(19) United States
(12) Patent Application Publication
(10) Pub. No.: US 2022/0153577 A1
(43) Pub. Date: May 19, 2022

(54) Process and system for conversion of composite waste into Hydrogen

(71) Applicant: Standard Hydrogen Company, Inc., Doylestown, PA (US)

(72) Inventors: Justin Soodjinda, Ontario (CA); James WASAS, Aurora (CA); Mariavicenta WASAS, Aurora (CA)

(21) Appl. No.: 17/523,604

(22) Filed: Nov. 10, 2021

Related U.S. Application Data
(60) Provisional application No. 63/114,308, filed on Nov. 16, 2020.

(51) Int. Cl. C01B 3/04; C01B 3/50; B01J 19/28; B01J 19/24; B09B 3/40

(52) U.S. Cl. CPC C01B 3/04; C01B 3/501; B01J 19/28; B01J 19/245; B01J 19/2465; B09B 2101/75; B01J 2219/1943; B01J 2219/00162; B01J 2219/00051; C01B 2203/1211; C01B 2203/041; B09B 3/40

(57) ABSTRACT

A reactive process for converting composite plastic waste into hydrogen gas and a reactor system for effecting such process.

### CROSS REFERENCE TO RELATED APPLICATIONS

This application claims priority to U.S. provisional patent application 63/114,308 filed on Nov. 16, 2020 and incorporated herein by reference.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a process and a reactor system for generating hydrogen gas from composite waste materials.

### Background of the Invention

Recycling of plastics has become more important over time, and many types of plastics can easily be recycled. That said, some of the most widely-used types of plastic, including those primarily used for food packaging, cause special problems for recyclers due to the use of multi-layered components, also known as composite packaging. It would be ideal to be able to efficiently separate the subcomponents of these plastic waste streams that are not currently considered recyclable and use the suitable parts of such waste to produce products of value. The most needed component found in these waste streams is hydrogen.

Hydrogen is a desirable fuel because it is clean-burning, in that its combustion produces only water and that it has the highest energy density of any fuel on earth. Currently, only two commercial methods are used for the mass production of hydrogen, the steam reformation of methane and the hydrolysis of water. Both known methods are expensive, inefficient, can cause contamination, and often produce unwanted carbon dioxide as well.

It is also known that sulfur is an abundant, inexpensive chemical that can be used in a reaction to release hydrogen atoms from their bond with the carbon atoms of a hydrocarbon in order to yield hydrogen sulfide. Further, hydrogen sulfide can be split into hydrogen and sulfur thus generating hydrogen from waste hydrocarbons and returning the sulfur that was used in the process.

A hydrogenation process, which is used to remove sulfur from hydrocarbons to convert them into hydrocarbons that do not contain sulfur so that they can be clean burning, has been employed by petroleum producers. Hydrogen sulfide is also produced by many industrial processes such as paper pulping, sewage treatment, reacting sulfur with hydrocarbons, and is also produced naturally by decaying organic matter, in sulfur hot springs and volcanos.

Hydrogen Sulfide is a colorless, corrosive, and highly toxic gas with an offensive rotten egg odor. Hydrogen sulfide's odor is readily detectable at low concentrations and it is a respiratory inhibitor, but because of its abundance and high flammability, it could serve as a fuel but for the sulfur dioxide produced during its combustion. However, splitting hydrogen sulfide in the absence of oxygen via catalytic decomposition of the hydrogen sulfide into sulfur and hydrogen, with the hydrogen to fuel the emerging hydrogen economy while also recovering the sulfur used in the process would be highly desirable.

Processes to remove hydrogen sulfide from gases are known. For example, hydrogen sulfide may be separated from gases by means of amine solvent extraction, adsorption, absorption or other means. Processes to recover sulfur from hydrogen sulfide are also known. For example, in a conventional sulfur recovery process, known as the Claus Process, up to about one third of the hydrogen sulfide in a gas may be oxidized with air or oxygen into sulfur dioxide to react with the balance of the hydrogen sulfide and produce elemental sulfur and water. Part of this process is accomplished at temperatures above 850 degrees Celsius, and part is accomplished in the presence of catalysts, such as activated alumina or titanium dioxide. The chemical reactions of the Claus Process are:

2H.sub.2S+3O.sub.2.fwdarw.2SO.sub.2+2H.sub.2O

4H.sub.2S+2SO.sub.2fwdarw.3S.sub.2+4H.sub.2O

Frequently, the sulfur produced is of low quality, must be refined before it can be sold or used commercially, and the water formed in the process is contaminated.

Another process is disclosed in U.S. Publication No. 2005/0191237. This publication discloses a process and apparatus for obtaining a hydrogen product and a sulfur product from a feed gas by separating the feed gas to obtain a purified hydrogen sulfide fraction of at least about 90% by volume hydrogen sulfide, dissociating the hydrogen sulfide in the hydrogen sulfide fraction to convert it into a purified hydrogen sulfide fraction of elemental hydrogen and sulfur, separating the dissociated purified hydrogen sulfide fraction to obtain a hydrogen rich fraction of elemental hydrogen, and obtaining the hydrogen product of elemental hydrogen. The dissociating is performed at a temperature of between 1500 and 2000 degrees Celsius.

U.S. Publication No. 2002/0023538 also discloses a process to remove hydrogen sulfide and other contaminants. This two-step process includes using a first adsorbent positioned in a fluidized bed operating at a temperature of about 20-60 degrees Celsius to remove at least a portion of the contaminants and using a second adsorbent positioned within another fluidized bed operating at a temperature of about 100-300 degrees Celsius to remove another portion of the contaminants from a gas. A conversion element, i.e., a nonthermal plasma corona reactor, is also disclosed for converting the contaminants to elemental sulfur and hydrogen at a temperature less than 400 degrees Celsius.

What is needed is a simple, efficient and cost-effective method of reacting composite plastic waste to produce hydrogen gas suitable for use or sale.

### BRIEF SUMMARY OF THE INVENTION

In a preferred embodiment, reactor system for converting composite waste into hydrogen gas, comprising: a first reactor containing reactants composite waste and nitrogen or other non-oxydizing gas, wherein the composite waste is heated to emit hydrocarbon gas; a second reactor containing sulfur, wherein the hydrocarbon gas from the first reactor is reacted with sulfur to produce hydrogen sulfide; a first buffering tank in which the hydrogen sulfide from the second reactor is pressurized and stored to produce a consistent pressure flowing feed to a third reactor; the third reactor wherein the hydrogen and sulfur of the hydrogen sulfide from the first buffering tank are disassociated into liquid sulfur and hydrogen gas products with a heating element and then separated with a membrane, allowing the liquid sulfur product to drain into a collection tank; and a second buffering tank in which the hydrogen gas from the third reactor is stored and buffered or normalized for commercial use.

In another preferred embodiment, the reactor system as described herein, wherein each reactor and tank is connected in sequence by a three-way valve connecting to an atmospheric flare and a pump, wherein the pump forwards the product of the preceding reactor or tank to the next reactor or tank.

In another preferred embodiment, the reactor system as described herein, wherein the first reactor is initially purged of air with a vacuum and nitrogen or other non-oxydizing gas is pumped into the first reactor from an inlet in place of the purged air.

In another preferred embodiment, the reactor system as described herein, wherein the liquid sulfur produced by the third reactor is recycled for use in the second reactor.

In another preferred embodiment, the reactor system as described herein, wherein one or more of the three-way valves are automatically shifted to atmospheric flare whenever all or part of the system is overpressurized.

In another preferred embodiment, the reactor system as described herein, wherein the first reactor chamber is operated at a pressure of approximately 20% of ambient atmospheric pressure and a temperature range of 150 C to 300 C.

In another preferred embodiment, the reactor system as described herein, wherein the first reactor is cylindrical, comprises a motor and an axis, wherein the first reactor spins on the axis.

In another preferred embodiment, the reactor system as described herein, wherein the spin rate is appropriate for efficient heat transfer and the controlled decomposition of composite hydrocarbon waste within the reactor.

In another preferred embodiment, a process of converting composite waste into hydrogen gas using the reactor system as described herein, comprising the steps of:
feeding composite waste into the first reactor;
partially filling the second reactor with sulfur;
purging the air from the first reactor and replacing the air with nitrogen or other non-oxydizing gas;
initiating the heating of the first reactor;
periodically removing the unreacted residue of the composite waste from the first reactor and the liquid sulfur from the second reactor when each is spent; and
replacing composite waste and sulfur as needed.

### BRIEF DESCRIPTION OF THE DRAWINGS

FIG. 1 is a line drawing evidencing the sequential steps of moisture removal and volatilization of the desirable hydrocarbons from the less volatile undesirable hydrocarbons, and converting them into hydrogen sulfide followed by splitting the hydrogen sulfide to recover the sulfur used for stripping, and hydrogen.

### DETAILED DESCRIPTION OF THE INVENTION

The invention provides a simple and efficient process for separating polyethylene and other volatile hydrocarbons from a composite plastic waste composed primarily of hydrocarbons, such as polyethylene, and low available hydrogen content hydrocarbons, such as cellulose. Alternate varieties of composite waste can comprise, without limitation, polyester, phenolic, epoxy, vinylester, polypropylene and PET resins, which are in some cases reinforced with glass and/or carbon fibre. The same process is applicable, in general, for separating more volatile hydrocarbons from less volatile materials, such as metals and ceramics.

In summary, the composite plastic waste is fed into a drier where the moisture contained in the plastic waste is removed, then fed to an oxygen free sub-atmospheric pressure reactor where heat, or other forms of electromagnetic radiation such as microwaves are used to separate the volatile hydrocarbons suitable for reacting with sulfur to produce hydrogen sulfide from the less volatile components unsuitable for reacting with sulfur to produce hydrogen sulfide.

The first stage of this process is subjecting the composite waste stream to heat, in the absence of oxygen or other oxidizing gases, and sub-ambient pressure to separate the polyethylene, in the form of volatile hydrocarbons, and other volatile hydrocarbons in general, from cellulose or other less volatile subcomponents. This is accomplished at temperatures of around 150 C to about 300 C by reducing the pressure in the reactor to about 20% of ambient while gently heating the contents of the reactor. A heated rotating reactor is ideal for rapid heat transfer to the hydrocarbons and volatilization. A preliminary drying process to remove humidity from the waste may also be found desirable, and the same heated rotating reactor may be employed for this process, or a separate drying system may optionally be employed.

The volatile, gaseous, hydrocarbons produced by the first reaction now proceed to a second reactor for the second step of the process. In this second step, the volatile hydrocarbons are reacted with liquid or gaseous sulfur to strip the hydrogen atoms from the hydrocarbons to produce hydrogen sulfide and carbon or carsuls. It is possible to produce carbon from this system by running the second reactor at a temperature of about 500 C or more. Hydrogen sulfide is produced by bubbling the hydrocarbon gas stream through liquid sulfur or mixing the streams of gaseous hydrocarbon and gaseous sulfur together. If desired, the hydrogen sulfide may be concentrated in preparation for storage or for utilization in stage 3 (hydrogen recovery). The methods for purifying hydrogen sulfide from the mixed gas stream in stage 2 may be from the use of amine solvent extraction, adsorption, absorption or other means. If desirable, the hydrogen sulfide produced in this second step may be stored as a liquid in a vessel, such as a gas cylinder, at a relatively low pressure of around 300 psi depending on the ambient temperature.

The third and final step of the process is splitting the hydrogen sulfide into hydrogen and sulfur to enable the reuse of the sulfur in step two, and use the hydrogen produced as deemed desirable. Various methods for splitting hydrogen sulfide into hydrogen and sulfur may be used as found in the art.

The disclosed technology creates a process that may be called the “sulfur cycle” in which hydrocarbons react with sulfur, which sulfure acts much like a catalyst, to strip the hydrogen atoms away from the carbon atoms of the hydrocarbon and then recover the sulfur for reuse by splitting the hydrogen sulfide. By the use of this process, waste hydrocarbons can simultaneously be used to produce hydrogen and eliminate hydrocarbon waste that might otherwise go into a landfill or waterway. In essence the “sulfur cycle” is a method that can be utilized to “de-carbonize” a fuel source or recycle composite or non-composite hydrocarbons.

The disclosed process results in the production of industrially and commercially useful and valuable hydrogen gas. The disclosed reactor design allows for such production to be simple and efficient, with the simplicity of the design also allowing for highly scalable production capacity. Moreover, the disclosed process is inexpensive compared to methodology currently known in the field, such that a production system with multiple reactors based on the disclosed design may produce large amounts of hydrogen for commercial use at prices well below those available on the market today.

The process of oxidizing the liberated hydrogen gas produced by the decomposition of hydrogen sulfide with air or oxygen is represented by the following equation:

2H.sub.2(g)+O.sub.2(g)fwdarw.2H.sub.2O(g)+energy

The energy released in this hydrogen oxidation process is far more than that required in the first reaction where hydrogen is released from its bond with sulfur as can be seen in the following table:

| | | | | | Gibbs | |
|---|---|---|---|---|---|---|
| | | | | Enthalpy | Free | Sponta- |
| | | | | (delta H) | Energy | neous |
| Reactant | Reactant | Product | Product | kj/mole | (AG) | T (K) |
| H₂S | | H₂ (g) | S (s) | 20.2 | 33.0 | −468.7 |
| 2H₂ (g) | O2 (g) | 2H₂O (g) | | −483.7 | −457.2 | 5449.0 |

The disclosed reactions result in the production of industrially and commercially useful and valuable hydrogen gas and can also recover the sulfur used in the process.

### DETAILED DESCRIPTION OF THE FIGURES

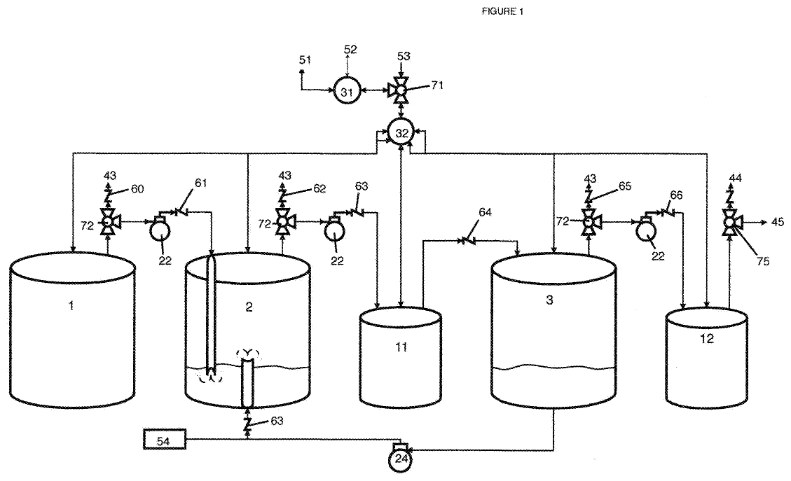

Turning now to the FIGURES, FIG. 1 shows a reactor system 10 for converting composite waste, wherein the composite waste is placed in a first reactor 1, which first reactor is then purged of air with a vacuum 51 by way of union 31, valve 71, and union 32. Nitrogen is then pumped into the system via nitrogen inlet 53 and thence to the first reactor to create an inert, non-oxidizing internal atmosphere. In these conditions, the first reactor contents are then heated to a range of approximately 150 C to 300 C, while the pressure in the reactor is concurrently reduced utilizing compressor pump 21 to about 20% of ambient atmospheric pressure. A heated rotating reactor is ideal for rapid heat transfer to the hydrocarbons and volatilization, so one embodiment of the first reactor includes the cylindrical first reactor spinning on an axle such that the contents are evenly heated.

First reactor 1 also incorporates 3-way valve 72 to allow release of excess pressure to an atmospheric flare 41 in the event of over-pressure, or connection to a pump 21 that sucks the hydrocarbon gas stream liberated by the heat and vacuum in first reactor 1 and pushes it into reactor 2 by way of a check valve 61. The gas content from the first reactor shall be comprised primarily of cracked hydrocarbon molecules from the polymer thermolysis reactions, but may also contain contaminants such as elemental carbon.

Valve 72 shall normally provide gas flow towards compressor pump 21 as pump 21 pulls cracked hydrocarbon gas from first reactor 1 past check valve 61 and towards the higher pressure second reactor 2. The check valve 61 will prevent backpressure of second reactor 2 from pushing sulfur or other gases within second reactor 2 back to the compressor pump 21.

The flow path 41 through check valve 60 should not be utilized in normal operation and is installed as an over pressure relief system to prevent catastrophic failure of first reactor 1. Since first reactor 1 is at a lower pressure than second reactor 2, compressor pump 21 is needed to move gas produced in first reactor 1 from an area of lower pressure to an area of higher pressure.

Pump 21 serves to push the hydrocarbon gas flow through check valve 61 gas tube 81 into the second reactor 2. Gas tube 81 directs the hydrocarbon gasses into hot liquid sulfur contained in the bottom of the reactor. The liquid sulfur reacts with the hydrocarbon gases producing hydrogen sulfide as shown in the formula below:

n[C.sub.2.H.sub.4(g)]+nS(l or g).fwdarw.n[H.sub.2.S](g)+C.sub.n

The hydrogen sulfide gas rises, along with fuming sulfur, and exits second reactor 2 via 3-way valve 73 which directs through check valve 62 and out atmospheric flare 42 only in the event of over-pressure, but otherwise to compressor pump 22 and check valve 63, which feeds into a buffer tank 11 that has been purged with nitrogen and evacuated. The purpose of buffer tank 11 is to serve as a medium holding location allowing a consistent pressure/hydrogen sulfide flow to third reactor 3 through check valve 64. This is required as the reaction rate of polymer to hydrogen sulfide (first reactor 1 and second reactor 2) is slower than the thermolysis reaction of hydrogen sulfide to hydrogen within third reactor 3.

The buffer tank 11 is connected to third reactor 3 by way of check valve 64. Buffer reactor 11 shall always be at a higher gauge pressure than third reactor 3, which will allow gas flow through the check valve 64.

In the third reactor 3, the hydrogen sulfide splits into hydrogen and sulfur to allow the reuse of the sulfur by way of pump 24 and check valve 63, and storage of the liquid sulfur product in sulfur storage vessel 54. This liquid sulfur can be recycled into the second reactor as stoichiometrically needed to continue the “sulfur cycle” and the decomposition of hydrocarbons into hydrogen sulfide and carbon. The hydrogen produced in third reactor 3 leaves via 3-way valve 75, which connects to emergency over-pressure atmospheric flare 43 by way of check valve 65, or to pump 23 to feed the hydrogen into a previously purged and evacuated hydrogen buffer/storage tank 12, which is similar in design, not necessarily material, as tank 11 for storing hydrogen instead of hydrogen sulfide. Buffer/storage tank 12 is also equipped with a 3-way emergency valve 75 for overpressure venting to atmospheric flare 43 via check valve 67, which valve will otherwise vent to a next process 45, which next process can be, without limitation, power generation via a hydrogen fuel cell, or other uses as known in the art.

All valves, pumps and vacuums used in the reactor system are designed to be motorized and operated electronically and controlled via a system to keep the gaseous contents from the previous reactor moving in the correct direction past the following check valve system. This mechanization is required to overcome either pressure differences between reactors or gas restraint such as hydrostatic pressure resistance created by liquid sulfur such as in reactor 2. Although the process of the invention may be performed in any apparatus or system capable of and suitable for performing each of the steps of the process as described herein, the process is preferably performed utilizing the preferred embodiments of the system as described herein. Accordingly, the terminology as used and defined in relation to one process and system is equally applicable with respect to another process and system.

While the invention has been described in detail and with reference to specific embodiments thereof, it will be apparent to one skilled in the art that various changes and modifications can be made therein without departing from the spirit and scope thereof. Thus, it is intended that the invention covers the modifications and variations of this invention provided they come within the scope of the appended claims and their equivalents.

### LIST OF REFERENCE NUMBERS

1 First reactor
2 Second Reactor
3 Third Reactor
10 Reactor System
11 Buffer tank
12 Buffer/storage tank
21-24 Pumps
31-32 Unions
41-44 Atmospheric flares
45 Next process outlet
51 Vacuum
52 Atmospheric inlet/outlet
53 Nitrogen inlet
54 Sulfur storage vessel
60-67 Check valves
71-75 3-way valves
81 gas tube

The references recited herein are incorporated herein in their entirety, particularly as they relate to teaching the level of ordinary skill in this art and for any disclosure necessary for the more common understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A reactor system for converting composite waste into hydrogen gas, comprising:
a first reactor containing reactants composite waste and nitrogen or other non-oxydizing gas, wherein the composite waste is heated to emit hydrocarbon gas;
a second reactor containing sulfur, wherein the hydrocarbon gas from the first reactor is reacted with sulfur to produce hydrogen sulfide;
a first buffering tank in which the hydrogen sulfide from the second reactor is pressurized and stored to produce a consistent pressure flowing feed to a third reactor;
the third reactor wherein the hydrogen and sulfur of the hydrogen sulfide from the first buffering tank are disassociated into liquid sulfur and hydrogen gas products with a heating element and then separated with a membrane, allowing the liquid sulfur product to drain into a collection tank; and
a second buffering tank in which the hydrogen gas from the third reactor is stored and buffered or normalized for commercial use.

2. The reactor system of claim 1, wherein each reactor and tank is connected in sequence by a three-way valve connecting to an atmospheric flare and a pump, wherein the pump forwards the product of the preceding reactor or tank to the next reactor or tank.

3. The reactor system of claim 1, wherein the first reactor is initially purged of air with a vacuum and nitrogen or other non-oxydizing gas is pumped into the first reactor from an inlet in place of the purged air.

4. The reactor system of claim 1, wherein the liquid sulfur produced by the third reactor is recycled for use in the second reactor.

5. The reactor system of claim 2, wherein one or more of the three-way valves are automatically shifted to atmospheric flare whenever all or part of the system is overpressurized.

6. The reactor system of claim 1, wherein the first reactor chamber is operated at a pressure of approximately 20% of ambient atmospheric pressure and a temperature range of 150 C to 300 C.

7. The reactor system of claim 1, wherein the first reactor is cylindrical, comprises a motor and an axis, wherein the first reactor spins on the axis.

8. The reactor system of claim 7, wherein the spin rate is appropriate for efficient heat transfer and the controlled decomposition of composite hydrocarbon waste within the reactor.

9. A process of converting composite waste into hydrogen gas using the reactor system of claim 1, comprising the steps of:
feeding composite waste into the first reactor;
partially filling the second reactor with sulfur;
purging the air from the first reactor and replacing the air with nitrogen or other non-oxydizing gas;
initiating the heating of the first reactor;
periodically removing the unreacted residue of the composite waste from the first reactor and the liquid sulfur from the second reactor when each is spent; and
replacing composite waste and sulfur as needed.
